(19) United States
(12) Patent Application Publication
(10) Pub. No.: US 2014/0292129 A1
(43) Pub. Date: Oct. 2, 2014

(54) THIN MOTOR

(71) Applicant: SANYO DENKI CO., LTD., Tokyo (JP)

(72) Inventors: Kouji Nakatake, Tokyo (JP); Masaaki Oohashi, Tokyo (JP)

(73) Assignee: SANYO DENKI CO., LTD., Tokyo (JP)

(21) Appl. No.: 14/220,641

(22) Filed: Mar. 20, 2014

(30) Foreign Application Priority Data
Mar. 26, 2013 (JP) 2013-064378

(51) Int. Cl. H02K 3/48; H02K 7/08

(52) U.S. Cl. CPC H02K 3/48; H02K 7/085
USPC 310/90; 310/216.001

(57) ABSTRACT

A thin motor includes a rotor 1 having permanent magnets and a stator having windings. In winding installation portions of the stator core, recesses are formed by reducing the thickness of the stator core, and the windings are accommodated in the recesses.

### BACKGROUND

1. Technical Field

The present invention relates to a thin motor having an improved installation structure of windings to a stator core.

2. Description of Related Art

Rotational driving devices of office automation equipment and optical instruments employ stepping motors and servomotors. In particular, mobile devices employ thin motors having a small axial length. In recent years, in order to promote the reduction in thickness of thin motors, developments have been proceeded with.

In the conventional HB (hybrid) type motor, windings are wound on the surface of a stator core with electric insulators therebetween (see, for example, Unexamined Japanese Patent Publication No. 2008-211942 (FIG. 5 and FIG. 7)) . Therefore, the windings are protruding from the surface of the stator core to both sides in the axial direction.

The conventional HB type motor has an inner rotor structure in which a rotor is disposed inside a stator. Therefore, a shaft fixed to the center of the rotor is supported by a bearing disposed outside the rotor.

In the conventional HB type motor, windings are protruding from the surface of a stator core to both sides in the axial direction, and therefore, the entire axial length of the motor is large. In addition, a shaft of the rotor is supported by a bearing disposed outside the rotor, and therefore, the entire axial length of the motor is large.

In particular, a rotor of the HB type motor has a structure in which permanent magnets are sandwiched between a pair of core members, and there is a limit to the reduction in thickness of the motor.

### SUMMARY

The present invention has been made in view of the above circumstances, and it is an object of the present invention to provide a thin motor having a small entire axial length and therefore a small thickness.

In order to attain the above object, a thin motor includes a rotor having permanent magnets and a stator having windings.

In winding installation portions of a core of the stator, recesses are formed by reducing the thickness of the stator core. The windings are accommodated in the recesses.

In the thin motor according to the present invention, windings are accommodated in recesses formed in winding installation portions of a stator core. Therefore, in the thin motor according to the present invention, the windings are not protruding from the surface of the stator core. The entire axial length of the motor can be reduced, and the reduction in thickness of the motor can be promoted.

### BRIEF DESCRIPTION OF THE DRAWINGS

FIG. 1 is a schematic sectional view of a thin motor according to this embodiment.

FIG. 2 is a schematic sectional view of a stator core of the thin motor according to this embodiment.

FIG. 3 is a front view of the stator core of the thin motor according to this embodiment.

FIG. 4 is a schematic sectional view of a stator of the thin motor according to this embodiment.

FIG. 5 is a front view of the stator of the thin motor according to this embodiment.

### DETAILED DESCRIPTION

Hereinafter, a thin motor according to this embodiment will be described with reference to the drawings.

In the thin motor according to this embodiment, recesses are formed in winding installation portions of a stator core by reducing the thickness of the stator core, and windings are accommodated in the recesses.

Therefore, the windings are not protruding from the surface of the stator core. That is, this embodiment can provide a thin motor having a small entire axial length and therefore a small thickness.

### Configuration of Thin Motor

First, the configuration of the thin motor according to this embodiment will be described with reference to FIG.

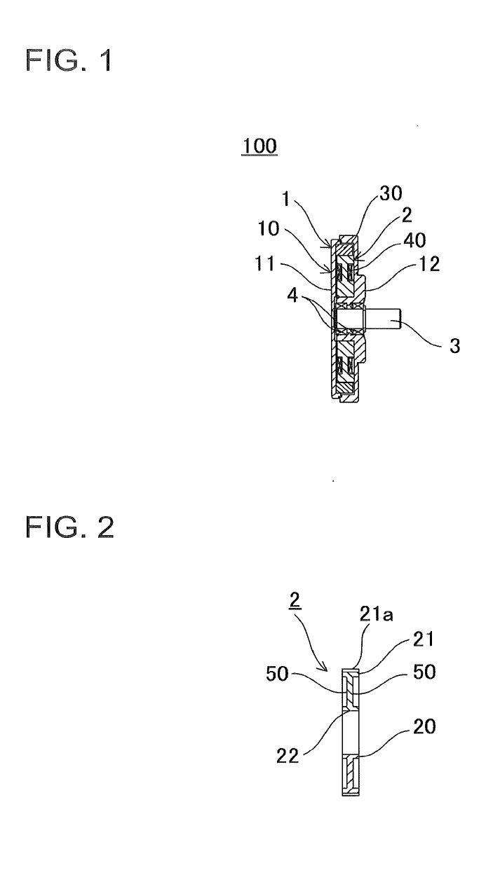

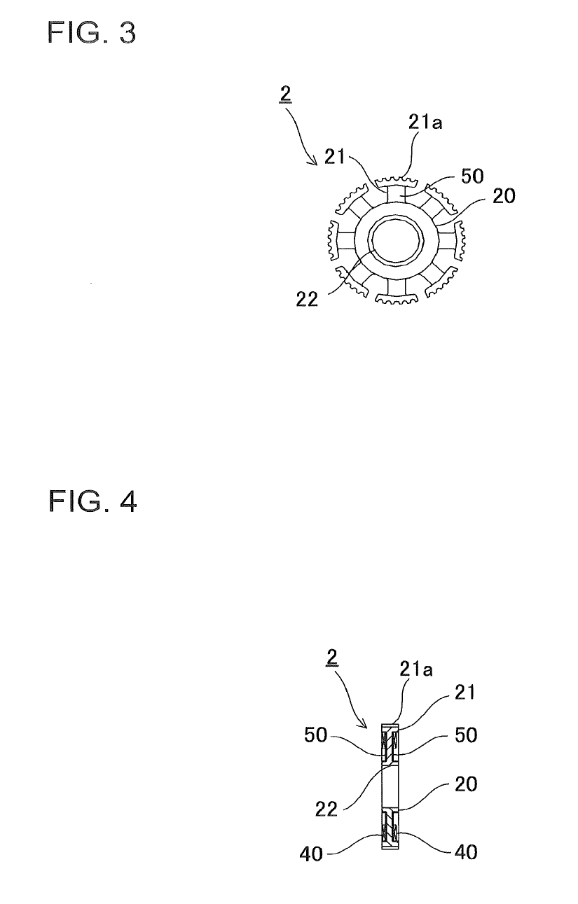

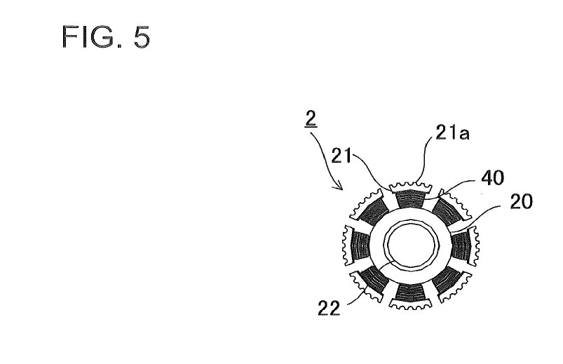

1 to FIG. 5. FIG. 1 is a schematic sectional view of the thin motor according to this embodiment. FIG. 2 is a schematic sectional view of a stator core of the thin motor according to this embodiment. FIG. 3 is a front view of the stator core of the thin motor according to this embodiment. FIG. 4 is a schematic sectional view of a stator of the thin motor according to this embodiment. FIG. 5 is a front view of the stator of the thin motor according to this embodiment.

The thin motor according to this embodiment is configured as, for example, a PM type stepping motor (Permanent Magnet Motor) , or a VR type stepping motor (Variable Reluctance Motor). The thin motor 100 exemplified in FIG. 1 includes a rotor 1 and a stator 2.

As shown in FIG. 1, the rotor 1 has a rotor core 10 and permanent magnets 30.

The rotor 1 is provided around a shaft 3 with a bearing 4 therebetween. In the thin motor 100 according to this embodiment, the bearing 4 is disposed inside the rotor 1.

The rotor core 10 includes a pair of disk-shaped core members 11 and 12 . The first core member 11 is, for example, a substantially ring-shaped flat plate member. The second core member 12 is, for example, a substantially ring-shaped flat plate member. The inner periphery 12a and the outer periphery 12b of the second core member 12 are protruding toward the first core member 11. A ring-shaped bearing 4 is interposed between the inner periphery 12a of the second core member 12 and the shaft 3.

Examples of the material of the rotor core 10 include, but are not limited to, a soft magnetic material such as silicon steel sheet.

The permanent magnets 30 are sandwiched between the outer peripheral parts of the pair of core members 11 and 12. The permanent magnets 30 are arranged at regular intervals along the circumferential direction of the rotor core 10. The permanent magnets 30 are magnetized, for example, alternately in N- and S-polarities along the circumferential direction of the rotor core 10. However, the present invention is not limited to this.

Examples of the permanent magnets 30 include, but are not limited to, rare-earth magnets such as neodymium magnets.

The thin motor 100 according to this embodiment has an outer rotor structure, and the stator 2 is disposed inside the rotor 1. The stator 2 has a stator core 20 and windings 40.

The stator core 20 is, for example, a substantially deformed ring-shaped (gear-shaped) flat plate member. A substantially circular through-hole 22 is formed in the central part of the stator core 20.

A plurality of teeth 21 for winding the windings 40 are provided in the outer peripheral part of the stator core 20. The plurality of teeth 21 are protruding radially in the outer peripheral part of the stator core 20. The teeth 21 have a substantially T-shape, and a plurality of small teeth 21a are formed at the distal end of each tooth 21.

The windings 40 are wound on the teeth 21. As shown in FIG. 2 and FIG. 3, recesses 50 for accommodating the windings 40 are formed in winding installation portions of the stator core 20. That is, the recesses 50 are formed by reducing the thickness of the stator core 20, and not by erecting boundary walls around the winding installation portions (see FIG. 5 of the above-mentioned Unexamined Japanese Patent Publication No. 2008-211942) . The recesses 50 are formed in both sides of the teeth of the stator core 20.

As shown in FIG. 4 and FIG. 5, the windings 40 are accommodated in the recesses 50 of the teeth 21. The windings 40 are accommodated in the recesses 50 and are not protruding from the surface of the stator core 20.

When the pole cross-sectional area of the windings 40 is 60% or less, magnetic saturation starts depending on the material. Therefore, the pole cross-sectional area of the stator 2 in the winding parts is set to 60% to 80% of the small teeth surface area of each pole, and the winding parts are secured. However, this does not apply to the case where the axial length of the stator core 20 is large.

By reducing the pole cross-sectional area not resulting from torque, accommodation parts for the windings 40 are secured.

Examples of the material of the stator core 20 include, but are not limited to, a soft magnetic material such as silicon steel sheet as with the rotor core 10.

### Operation of Thin Motor

Next, the operation of the thin motor 100 according to this embodiment will be described with reference to FIG. 1 to FIG. 5.

As shown in FIG. 1, the rotor 1 of the thin motor 100 according to this embodiment has a plurality of permanent magnets 30 sandwiched between core members 11 and 12. The plurality of permanent magnets 30 are magnetized, for example, alternately in N- and S-polarities along the circumferential direction.

The stator 2 is provided inside the rotor 1, and has a plurality of windings 40 arranged radially in the circumferential direction.

That is, in the thin motor 100 according to this embodiment, current flows through the windings 40 of the stator 2 so as to intersect with magnetic flux generated by the permanent magnets 30 of the rotor 1. When the magnetic flux of the permanent magnets 30 intersects with the current flowing through the windings 40, the thin motor 100 according to this embodiment generates circumferential driving force in the rotor 1 having the permanent magnets 30 by electromagnetic induction, and rotates the rotor 1 about the shaft 3.

In the thin motor 100 according to this embodiment, recesses 50 are formed in winding installation portions of the stator core 20 by reducing the thickness of the stator core 20. The windings 40 are accommodated in the recesses 50, and the windings 40 are not protruding from the surface of the stator core 20.

That is, the thin motor 100 according to this embodiment has a structure in which the windings 40 wound on the stator core 20 are prevented from affecting the entire axial length of the motor. Therefore, according to the thin motor 100 according to this embodiment, the entire axial length of the motor can be reduced, and the reduction in thickness of the motor can be promoted. The winding installation space on the conventional stator core 20 can be used effectively.

Since the windings 40 are accommodated in the recesses 50 of the stator core 20, the contact region between the windings 40 and the stator core 20 increases. By the increase in the contact region between the windings 40 and the stator core 20, heat dissipation properties of the stator 2 can be improved.

The thin motor 100 according to this embodiment has an outer rotor structure in which the stator 2 is disposed inside the rotor 1. By adopting the outer rotor structure, the bearing is located inside the rotor 1, and the entire axial length of the motor can be reduced.

The VR type stepping motor or the PM type stepping motor has low output torque compared to the HB type stepping motor due to the difference in magnetomotive force between permanent magnets. So, the thin motor 100 according to this embodiment has an outer rotor structure in which the facing area between the stator 2 and the rotor 1 is large, in order to compensate for low torque. Therefore, the thin motor 100 having the outer rotor structure according to this embodiment has the same torque as the conventional HB stepping motor having the inner rotor structure.

That is, the thin motor 100 according to this embodiment has a small entire axial length, high torque, and high performance due to the improved heat dissipation properties. Thus, a high value added motor can be provided.

Although the preferred embodiments of the present invention have been described above, they are illustrative for explaining the present invention, and the scope of the present invention is not limited to the embodiments. The invention can be executed in various modes different from the foregoing embodiments without departing from the gist of the invention.

1. A thin motor comprising:
a rotor having permanent magnets; and
a stator having windings,
wherein in winding installation portions of a core of the stator, recesses are formed by reducing the thickness of the stator core, and the windings are accommodated in the recesses.

2. The thin motor according to claim 1, wherein the thin motor has an outer rotor structure in which the stator is disposed inside the rotor, and the rotor is supported by a shaft with a bearing therebetween.

3. The thin motor according to claim 1, wherein the thin motor is a VR type stepping motor or a PM type stepping motor.
